(19) United States
(12) Patent Application Publication
(10) Pub. No.: US 2026/0278468 A1
(43) Pub. Date: Sep. 17, 2026

(54) Framework for Large-Scale Distributed Language Model Training

(71) Applicant: 4MindsAI Inc., Dallas, TX (US)

(72) Inventors: Kubashen Jerome Naidoo, Heath, TX (US); Ahmadreza Azizi, Fresco, TX (US); Aviraj Sinha, Dallas, TX (US); Kevin Johann Andrade, Dallas, TX (US); Steven Dennis Bell, Dallas, TX (US); Georgiy Mamedaliev, Wylie, TX (US); Jason Nocco, Manhattan Beach, CA (US); Ryan Trimberger, San Pedro, TX (US)

(21) Appl. No.: 19/563,165

(22) Filed: Mar. 11, 2026

Related U.S. Application Data
(60) Provisional application No. 63/770,201, filed on Mar. 11, 2025.

(51) Int. Cl. G06N 20/00; G06N 5/022

(52) U.S. Cl. CPC G06N 20/00; G06N 5/022

(57) ABSTRACT

Technology embodied in a method of training a large language model (LLM), the method including receiving a training corpus for the LLM, processing the training corpus to generate one or more knowledge graphs, and extracting, from the one or more knowledge graphs, causal relationships between various nodes of the one or more knowledge graphs. The method further includes augmenting the training corpus with the causal relationships extracted from the one or more knowledge graphs, and executing a training of the LLM using the augmented training corpus.

### CROSS-REFERENCE TO RELATED APPLICATIONS

This application claims the benefit under 35 U.S.C. § 119(e) of the filing date of U.S. Patent Application No. 63/770,201, which was filed on Mar. 11, 2025, and which is incorporated here by reference.

### TECHNICAL FIELD

The technology described in this document relates to artificial intelligence.

### BACKGROUND

Knowledge graphs are structured representations designed to organize information as interconnected entities, known as nodes, and relationships or edges that connect these entities, capturing their semantic inter-dependencies. Nodes typically represent real-world objects or concepts, while edges represent the relationships or interactions between them.

### SUMMARY

In one aspect, this document features a method of training a large language model (LLM), the method including receiving a training corpus for the LLM, processing the training corpus to generate one or more knowledge graphs, and extracting, from the one or more knowledge graphs, causal relationships between various nodes of the one or more knowledge graphs. The method further includes augmenting the training corpus with the causal relationships extracted from the one or more knowledge graphs, and executing a training of the LLM using the augmented training corpus.

In another aspect, this document features a system of multi-agent reinforcement learning, the system including a primary machine-learning model configured to process training data to generate a model-response, and at least one auxiliary machine-learning model configured to process the model response to evaluate a quality of the model response. The primary machine-learning model is fine-tuned in accordance with the quality of the model-response as evaluated by the at least one auxiliary model.

Implementations can include one or more of the following features.

The training corpus can include multi-modal data. The one or more knowledge graphs can include causal graphs indicative of cause-effect relationships among different modalities of the multi-modal data. The method can include dynamically updating the one or more knowledge graphs during the training of the LLM. The one or more knowledge graphs can be dynamically updated using a counterfactual regret minimization (CFRM) process configured to simulate multiple alternative scenarios to predict corresponding outcomes. The one or more knowledge graphs can be dynamically updated by preserving topological features that appear in multiple of the various alternative scenarios. The topological features can be identified using persistent homology (PH) analysis. At least one of the updated knowledge graphs represents a structural prior used during executing an inference process using the trained LLM.

The one or more knowledge graphs representing the multi-modal data can include multi-dimensional tensors where different modalities of the multi-modal data are represented as different axes. The training of the LLM using the augmented corpus can include processing data from the augmented corpus by the LLM to generate a model-response, processing the model-response by at least one auxiliary machine-learning model to evaluate a quality of the model response, and updating training of the LLM in accordance with the quality of the model response.

The at least one auxiliary machine-learning model can be a generative artificial intelligence model configured to evaluate the model-output based on a prompt. Executing the training of the LLM can include updating weights of a self-attention mechanism associated with the LLM based on the causal relationships extracted from the one or more knowledge graphs. Similarity measures associated with the self-attention mechanism can be dynamically modified as a function of the updated weights.

The primary machine-learning model can be trained on multi-modal data comprising data of multiple modalities. Each of the at least one auxiliary machine-learning model can be trained on data of a corresponding one of the multiple modalities. Evaluating the quality of the model response can include comparing the model response to corresponding ground truth data. The primary machine-learning model can be fine-tuned in accordance with the quality of the model-response based on a supervised fine-tuning (SFT) process. The quality of the model-response can be represented by at least one of a quantitative score or qualitative feedback generated by the at least one agent. The quality of the model-response can be represented using a composite reward score generated as a weighted combination of multiple individual reward components. The individual reward components can represent one or more of: factual correctness, reasoning depth, coherence, or alignment with task-specific objectives. The at least one machine learning model can be a generative artificial intelligence model configured to evaluate the model-output based on a prompt. The primary machine-learning model can be an large language model (LLM). The at least one auxiliary machine-learning model can include multiple auxiliary machine-learning models each of which processes the model-output in parallel to at least one other of the multiple auxiliary machine-learning models. At least one of the primary machine-learning model or the auxiliary machine-learning model can be a virtual large language model (vLLM).

The details of one or more embodiments are set forth in the accompanying drawings and the description below. Other features, objects, and advantages will be apparent from the description and drawings, and from the claims.

### BRIEF DESCRIPTION OF DRAWINGS

FIG. 1. is an example of a knowledge graph.

FIG. 2 is an example of a reinforcement learning framework.

FIG. 3A is a schematic diagram of an example of supervised fine tuning with dynamic self-learning graph.

FIG. 3B is a schematic diagram of an example of multi-agent reinforcement learning for large language model (LLM) tuning.

FIG. 4 is an example visualization of a knowledge graph.

FIG. 5 is another example visualization of a knowledge graph.

FIG. 6 is another example visualization of a knowledge graph.

FIG. 7 is a flow diagram of an example process for training a large language model (LLM).

Like reference symbols in the various drawings indicate like elements.

### DETAILED DESCRIPTION

This document presents a framework for large-scale distributed language model training that integrates a graph-based knowledge approach and reinforcement learning reasoning with advanced production-grade technologies. The technology incorporates dynamic causal graph reasoning directly within the data preparation and fine-tuning processes at the model layer, enhancing reasoning capabilities beyond Retrieval-Augmented Generation (RAG) methods. Furthermore, by employing Instructed Supervised Fine-Tuning (Instruct SFT) and reinforcement learning techniques, significant reasoning improvements, particularly in complex mathematical reasoning tasks can be realized.

GPU parallelism techniques, including Deep-Speed's pipeline parallelism, Torch native training acceleration packages, and/or message passing interfaces (MPI) combined with Kubernetes infrastructure, are leveraged to optimize memory efficiency and computational performance across multiple nodes. These frameworks are integrated strategically to optimize large-scale models, achieving high performance in distributed environments. Additionally, custom communication protocols are implemented to minimize latency between pipeline stages and optimize data transfer between model segments. Custom workflows have been developed to manage training job lifecycles and automate scaling based on workload demands, thereby extending standard Kubernetes functionality with ML-specific capabilities.

Knowledge graphs are utilized to enhance reasoning, representing a strategy for improving Large Language Model (LLM) performance. While current AI solutions typically apply graph methods with semantic embeddings at the Retrieval-Augmented Generation (RAG) layer, causal graph reasoning can be integrated directly into the data and fine-tuning processes. This integration enables structured relational knowledge to be encoded as embedded graph representations within the model architecture, supporting explicit reasoning over relationships during inference. Moreover, these knowledge representations are dynamically updated during training, creating an adaptive semantic foundation that evolves alongside the model's understanding of various domains.

A specialized Supervised Fine-Tuning (SFT) trainer has been developed, extending general implementations with domain-specific optimizations. Advanced techniques such as gradient accumulation, tailored learning rate scheduling for fine-tuning objectives, and checkpointing strategies optimized for distributed infrastructure are incorporated.

Advantages in employing graph reasoning are demonstrated by optimizing internal parameters based on explicit relational and causal patterns encoded within knowledge graphs. Improved reasoning accuracy across mathematical benchmark datasets, notably in tasks requiring multistep reasoning, is indicated by comparative analysis. Furthermore, a benchmarking framework has been developed to evaluate system performance across multiple dimensions, including training throughput, GPU utilization efficiency, and model convergence rates. Baseline metrics for comparison against industry standards have been established, and performance improvements are tracked through iterative optimizations. Integrated into a CI/CD pipeline, the benchmarking process ensures infrastructure changes maintain or enhance performance characteristics. Detailed performance profiles for each training run can be automatically generated by the framework.

The technology also includes a reinforcement learning feedback pipeline, which incorporates specialized agents to implement and optimize reward functions. Model outputs are assessed against defined quality criteria by these agents, generating reward signals to guide training toward desired outcomes. The agent architecture supports both rule-based and learned reward models, including mechanisms for human feedback integration to continuously refine the reward function, enabling iterative improvement aligned with specific quality objectives. Depending on the problem specifics, Proximal Policy Optimization (PPO), Group Relative Policy Optimization, and Length Controlled Policy Optimization (LCPO) with custom stability enhancements are employed, effectively leveraging these reward signals while preventing divergence.

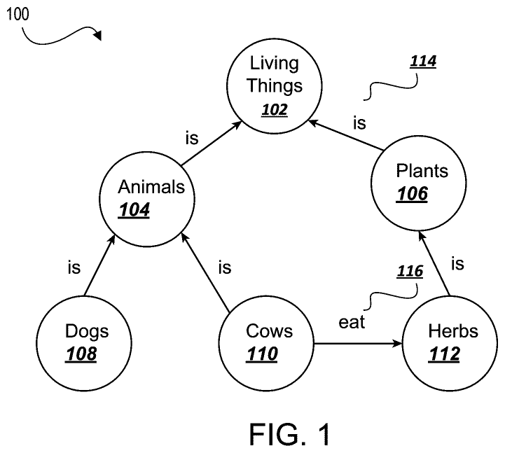

FIG. 1 illustrates an example of a knowledge graph 100. Knowledge graphs are structured representations that organize information as interconnected entities, known as nodes, e.g., nodes 102, 104, 106, 108, 110, and 112 of the knowledge graph 100. Knowledge graphs represent the relationships or edges that connect these entities, capturing their semantic inter-dependencies. For example, knowledge graph 100 includes a plurality of edges such as edge 114 and edge 116. Nodes typically represent real-world objects or concepts, while edges represent the relationships or interactions between them.

In the knowledge graph 100, the ‘Living Things’ node 102 connects to the ‘Animals’ node 104 and the ‘Plants’ node 106 through ‘is’ relationships, such as the relationship represented by the edge 114, establishing a hierarchical structure. Further, the ‘Animals’ node 104 branches into specific examples such as the ‘Dogs’ node 108 and the ‘Cows’ node 110, each connected again through an ‘is’ relationship, indicating categorization. An additional edge 116 labeled ‘eat’ shows a non-hierarchical interaction, illustrating the relationship between the ‘Cows’ node 110 and the ‘Herbs’ node 112. Such graphs efficiently encode semantic information, enabling queries, inferences, and complex reasoning tasks by clearly representing relationships among entities.

The technology described herein includes an approach to modeling text data (which can be extended to multi-modal/multi-source data) within a knowledge graph structure, enabling Large Language Models (LLMs) to discover relationships within the graph. This typically serves as a preprocessing mechanism for structured data, providing an alternative to prompt engineering and Retrieval-Augmented Generation (RAG). A graph-based preprocessing mechanism could function similarly to vector databases but encode reasoning connections rather than semantic similarities, streamlining structured data processing and improving accuracy while reducing dependence on engineered prompts. While RAG depends on embedding retrieval from a vector store, the technology described herein integrates graph-structured data natively, making it a context-aware approach. In some implementations, the technology described herein could significantly reduce hallucination issues when constrained with a graph-based reasoning layer.

Some AI systems employ Graph Neural Networks (GNNs) to process structured relationships between entities. However, knowledge graphs explicitly encode correct relationships between different entities, resulting in controlled and accurate reasoning. Knowledge graphs and multimodal fusion techniques are leveraged in RAG and other LLM applications. LLMs demonstrate proficiency in embedding-based similarity analysis, suggesting their ability to process graph node and edge representations to infer new relationships. Additionally, attention-based transformers trained on structured graph embeddings can enhance this capability. Recent advancements in integrating LLMs with Knowledge Graphs (KGs) have demonstrated significant improvements in structured reasoning and factual consistency. See, for instance, Dernbach, S., Agarwal, K., Zuniga, A., Henry, M., & Choudhury, S. (2024), Glam: Fine tuning large language models for domain knowledge graph alignment via neighborhood partitioning and generative subgraph encoding; also Pan, S., Luo, L., Wang, Y., Chen, C., Wang, J., & Wu, X. (2024), Unifying large language models and knowledge graphs: A roadmap, IEEE Transactions on Knowledge and Data Engineering, 36 (7), 3580-3599. These studies highlight the importance of structured knowledge in improving AI inference and interpretability.

While some techniques focus on augmenting Large Language Models (LLMs) with external knowledge sources, they do not directly optimize the structure and reasoning processes of the knowledge graph itself during the training process. Implementations of the technology described herein can include a novel graph processing layer specifically designed for LLM preprocessing. Unlike Retrieval-Augmented Generation (RAG) or vector embedding techniques, which rely on static knowledge representations, the technology described herein dynamically refines the knowledge graph based on LLM outputs using reinforcement learning (RL), allowing for real-time updates and adaptive knowledge structuring. The technology thus extends beyond existing graph-based AI models by incorporating a graph processing layer specifically designed for adaptively tuning the LLM's understanding during the training process, thereby showing performance improvements over RAG or vector embedding methods, which simply improve prompting or append information to data for fine-tuning. The technology described herein also contributes to real-time multimodal data understanding in AI-driven applications by providing an adaptive mechanism wherein the graph structure evolves based on LLM outputs, refining future predictions.

In some implementations, reinforcement Learning (RL) is specifically used to enhance the usage of knowledge graphs for language modeling. Unlike static Knowledge Graphs (KGs), attention-derived graphs are continuously reconfigured with each forward pass, with edge weights adapted based on contextual relevance. Several aspects of transformers are illuminated by this graph-theoretical framework: multi-head attention effectively implements multiple graph views with different connectivity patterns; the softmax normalization ensures outgoing edges from each node sum to 1.0, analogous to probability distributions in graph random walks; and the matrix multiplication with values (V) performs message-passing operations similar to those in Graph Neural Networks. The attention mechanism in transformer-based models¹ is mathematically defined in Equation (1): 1 Vaswani, A., Shazeer, N., Parmar, N., Uszkoreit, J., Jones, L., Gomez, A. N., Kaiser, Ł, & Polosukhin, I. (2017). Attention is all you need.

$$Attention ( Q , K , V ) = softmax ( \frac{{QK}^{T}}{\sqrt{{d}_{k}}} ) V \qquad ( 1 )$$

Here, Q, K, V represent the query, key, and value matrices, respectively, and dₖ denotes the dimensionality of the key vectors. The scaling factor (1/√dₖ) in Equation (1) ensures numerical stability, preventing excessively large dot products that could skew the attention distribution.

The scaled dot-product attention computes scores that quantify the relevance or similarity of each word relative to others in the input sequence, thus forming an attention distribution highlighting significant relationships between tokens. A simple illustrative example of such an attention score matrix, representing pairwise attention between tokens in the sentence “I have food . . . ”, is presented in Equation (2):

$$\begin{matrix} & I & have & food & … \\ I & 1. & 0.2 & 0.1 & … \\ have & 0.2 & 1. & 0.3 & … \\ food & 0.1 & 0.3 & 1. & … \\ … & … & … & … & …\end{matrix} \qquad ( 2 )$$

In Equation (2), the matrix entries correspond to attention scores, with higher values indicating stronger relevance between token pairs. The diagonal elements reflect self-attention, indicating the attention each token gives to itself. The attention mechanism in transformers fundamentally operates as a dynamic, weighted graph computation where tokens represent nodes and attention weights form directed edges. The attention matrix in Equation (2) directly corresponds to an adjacency matrix of a fully connected graph, with each entry (i, j) quantifying information flow from token j to token i.

This perspective enables novel architectural integrations, such as incorporating explicit graph structure priors from KGs to bias attention toward semantically meaningful connections or applying graph sparsification techniques to improve computational efficiency by pruning low-weight edges. Furthermore, attention maps can be leveraged as graph structure discovery mechanisms, potentially extracting latent semantic or syntactic relationships that could enhance downstream KG construction. The synthesis of transformer attention mechanisms with graph-based learning offers promising directions for both improving model performance and enhancing interpretability through visualizable attention-graph structures.

Reinforcement Learning (RL) and Multi-Agent Reinforcement Learning (MARL) have gained attention for their role in dynamic decision-making under uncertainty, particularly in cybersecurity and reasoning applications. RL and MARL provide adaptive responses to adversarial environments, with structured frameworks for cybersecurity integration.² In some implementations, the technology described herein can improve the training of attention weights using specific techniques found in RL and graph neural networks. 2 Mavroudis, V., Palmer, G., Farmer, S., Whitehead, K. S., Foster, D., Price, A., Miles, I., Caron, A., & Pasteris, S. (2025). Guidelines for applying rl and marl in cybersecurity applications

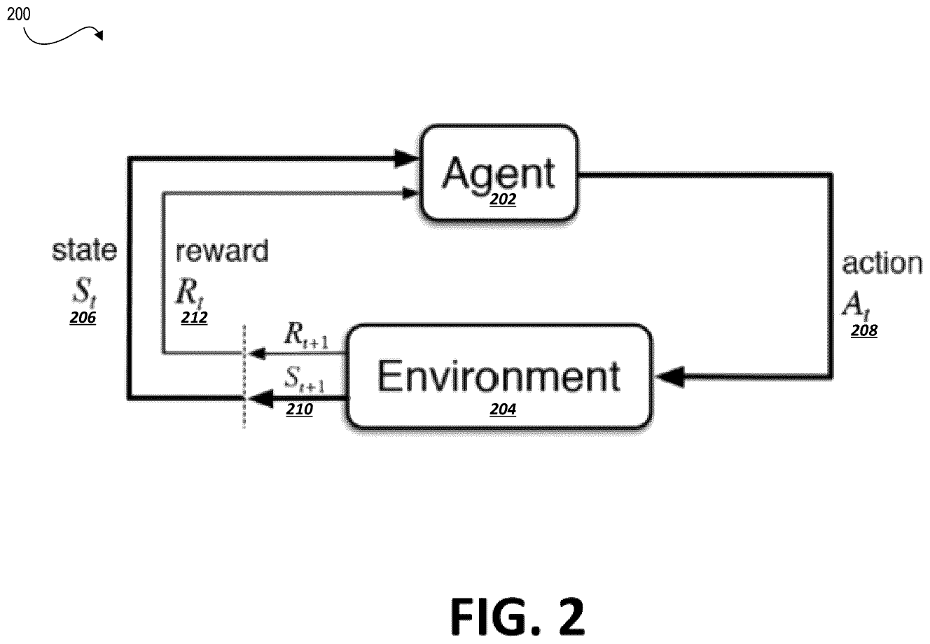

FIG. 2 illustrates an example reinforcement learning framework 200. In the reinforcement learning framework 200, an agent 202 interacts with an environment 204 through a continuous cycle of actions and observations. At each timestep t, the agent 202 observes the current state 206 Sₜ from the environment 204. Based on this observed state 206, the agent 202 selects an action 208 Aₜ, which is then executed within the environment 204. Following this action 208, the environment 204 transitions to a new state 210 Sₜ₊₁, and the agent receives a reward 212 Rₜ₊₁.

This interaction loop continues iteratively, with the agent 202 continually updating its policy—a strategy for action selection—based on the rewards it receives from the environment 204. The primary objective of reinforcement learning is to optimize the agent's actions to maximize cumulative reward over time. In some implementations, the training of attention weights can be improved by using advanced techniques derived from reinforcement learning principles and graph neural networks.

The equation presented in Eq. (3) describes the gradient of the expected reward Rᵢ with respect to the parameters θ, which can be important in policy optimization techniques used in reinforcement learning. The formulation is given as:

$$∇ {R}_{i} = \frac{\partial {R}_{i}}{\partial θ} = {𝔼}_{τ \sim {π}_{θ}} [ {\sum }_{t} {∇}_{θ} log P ( {a}_{t} \vert {s}_{t} , θ ) {R}_{i} ] . \qquad ( 3 )$$

In this equation, Rᵢ represents the reward function for a given criterion i, which serves as a metric to evaluate the performance of the policy. The parameter set θ defines the policy that governs the agent's decision-making process. The term ∇R; expresses the gradient of the reward function with respect to θ, which provides a direction for improving the policy through optimization. The expectation operator E_{τ~πθ} denotes averaging over trajectories τ sampled from the current policy πθ, ensuring that updates consider the stochastic nature of decision-making. The probability P(aₜ|sₜ, θ) represents the likelihood of selecting action aₜ given the state sₜ under the policy parameterized by θ. The policy gradient term ∇θ log P(aₜ|sₜ, θ) quantifies how changes in θ influence the selection probability of action aₜ, guiding adjustments toward more favorable actions. The reward function Rᵢ appears within the expectation to weight gradient contributions based on their associated returns. The summation Σₜ accumulates these contributions across all time steps in the trajectory, ensuring that the entire sequence of decisions influences policy updates. Moreover, Eq. (4) defines a normalization technique to improve stability and comparability across different reward distributions:

$${A}_{i} = \frac{{r}_{i} - {μ}_{r}}{{σ}_{r}} . \qquad ( 4 )$$

Here, Aᵢ represents the normalized reward for a given sample i, adjusting for distributional differences to ensure fair comparisons. The term rᵢ denotes the raw reward value for sample i, while μᵣ is the mean reward across all samples in the dataset, centering values around zero. The denominator σᵣ corresponds to the standard deviation of the reward distribution, scaling the normalized rewards to unit variance. In reinforcement learning, this normalization step can prevent large reward disparities from dominating policy updates, thereby improving the stability and convergence of learning algorithms.

The reward function provides an immediate signal to the agent about how good or bad an action is in a given state. To utilize knowledge graphs effectively with LLMs, information about knowledge graph connections and general rewards for coherent language output can be used. A reward function can be used that incorporates statistical information about language in certain domains. The total reward function, defined by Eq. (5), integrates multiple specialized rewards into a cohesive metric designed to evaluate the model's performance comprehensively:

$${R}_{i} = {B}_{1} {R}_{causal} + {B}_{2} {R}_{logical} + {B}_{3} {R}_{generalization} + {B}_{4} {R}_{efficiency} \qquad ( 5 )$$

In reinforcement learning and optimization frameworks, designing an effective reward function can help to guide the model toward desired behaviors. The total reward function in this formulation balances multiple aspects of model performance, encapsulating logical consistency, generalization ability, and computational efficiency. Each of these terms is weighted by coefficients B₁, B₂, B₃, and B₄, allowing for flexibility in prioritizing different learning objectives depending on the application context.

The logical reward component, represented by Eq. (6), is based on Shannon entropy, a fundamental measure of uncertainty in probabilistic inference:

$${R}_{logical} = - H ( {P}_{inference} ) = - {\sum }_{i = 1}^{N} {P}_{i} log {P}_{i} \qquad ( 6 )$$

The Equation 6, quantifies how spread out or uncertain the model's output probability distribution is. Higher entropy corresponds to more ambiguous predictions, while lower entropy indicates more decisive classifications. By minimizing entropy, this term encourages the model to produce more confident predictions, reducing uncertainty in decision-making.

The generalization reward given by Eq. (7) measures how well the model adapts across different domains using Kullback-Leibler (KL) divergence, a common metric for assessing distributional differences:

$${R}_{generalization} = - {D}_{KL} ( {P}_{domain 1} ‖ {P}_{domain 2} ) = - {\sum }_{i} {P}_{i} log \frac{{P}_{i}}{{Q}_{i}} \qquad ( 7 )$$

Here, Pdomain1 and Pdomain2 represent the probability distributions of model outputs across two different domains or datasets. The KL divergence quantifies how much information is lost when using Pdomain1 to approximate Pdomain2. A lower KL divergence implies that the model generalizes well across different conditions, maintaining similar prediction distributions regardless of changes in data characteristics.

The efficiency reward component in Eq. (8) addresses computational efficiency by penalizing model complexity and inference time:

$${R}_{efficiency} = - ( \frac{\vert ε \vert}{{\vert 𝒰 \vert}^{2}} + \frac{{Time}_{inference}}{{T}_{optimal}} ) \qquad ( 8 )$$

This equation includes two terms: the first term, |ε|/|U|², measures the density of computational operations in the model, where |ε| represents the number of edges (connections) in the computational graph, and |U|² represents a normalization factor based on the total number of possible connections. The second term, Time_{inference}/Tₒₚₜᵢₘₐₗ, penalizes models that use longer processing times relative to an optimal baseline Tₒₚₜᵢₘₐₗ, promoting architectures that are both lightweight and efficient.

In various implementations, the technology described herein can be used to implement the following. By integrating Kubernetes-enhanced causal reasoning³, counterfactual simulations, and self-evolving graph models, the proposed framework can be configured to reduce AI hallucinations, improving trust and reliability. Unlike static AI methods, the technology described herein uses, in some implementations, self-evolving graphs that adapt dynamically through continuous feedback loops. 3 Agrawal, M., Kayal, N., & Saxena, N. (2004). Primes is in p. Annals of mathematics, 781-793.

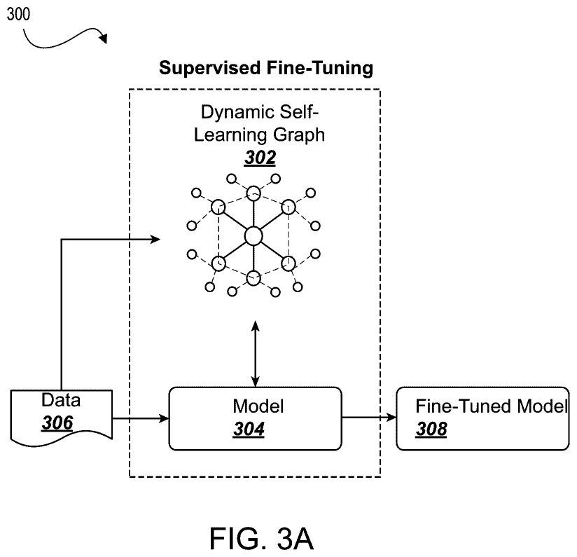

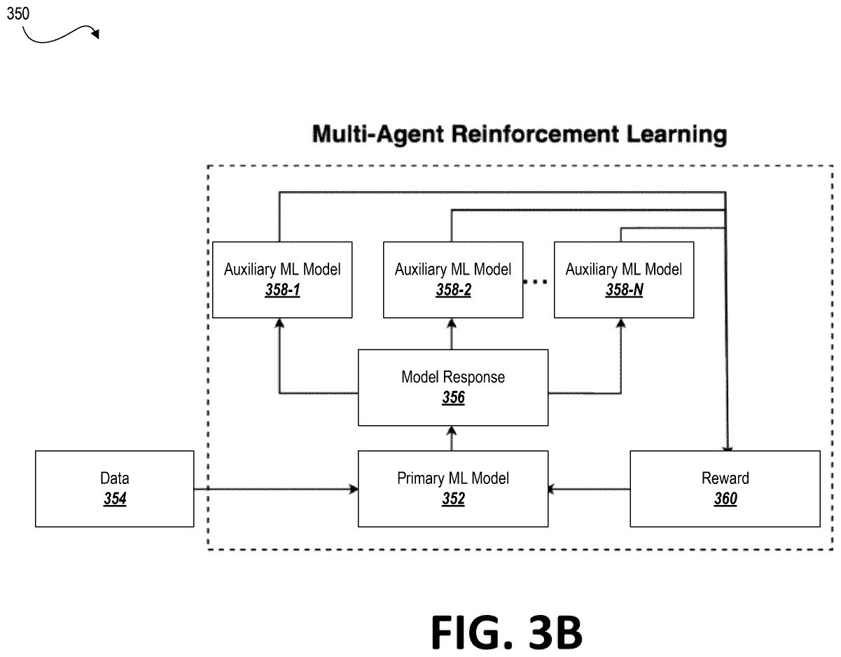

FIG. 3A is a schematic diagram 300 of an example of supervised fine tuning with dynamic self-learning graph 302. The graph 302 interacts with a model 304. For example, the graph 302 can be used to augment a training corpus that is used to train the model 304. During the training of the model 304, the graph 302 can be dynamically updated. This process can form a continuous feedback loop that includes both training the model 304 on a training corpus that is augmented by the graph 302, and updating the graph 302 via the training of the model 304.

The model 304 is trained using data 306. The data 306 that is used to train the model 304 can inform the graph 302. For example, the graph 302 can be updated based on the data 306. As a result of training the model 304 using the graph 302 and the data 306, the supervised fine tuning can generate a fine-tuned model 308. The fine-tuned model 308 can be the result of updating the model 304, e.g., updating parameters of the model 304, via training the model 304 using the graph 302 and the data 306.

As shown in FIG. 3A, self-evolving graphs that adapt dynamically through continuous feedback loops can enable real-time refinement of the knowledge base, enhancing adaptability and predictive accuracy. In some implementations, the technology employs hierarchical causal graphs and Counter Factual Regret Minimization (CFRM), enabling AI to differentiate between true causation and mere correlation. This structured reasoning could improve logical consistency and accuracy. The integration of specialized multi-agent systems transforms single-pass inference into a robust verification process, reducing misinformation and bias.

FIG. 3B is a schematic diagram of an example of multi-agent reinforcement learning system 350 for large language model (LLM) tuning. In the multi-agent reinforcement learning system 350 of FIG. 3B, a primary machine learning (ML) model 352 processes training data 354 to generate a model response 356. The training data 354 can include data of multiple modalities.

The primary ML model 352 can be a large language model (LLM). In some examples, the primary ML model 352 can be a virtual LLM (vLLM). The primary ML model 352 can have been trained on multi-modal data including data of multiple modalities, such as the training data 354.

Each of a set of auxiliary ML models 358-1-358-N process the model response 356 to evaluate a quality of the model response 356. In some implementations, at least one of the auxiliary ML models 358-1-358-N can be a generative artificial intelligence model configured to evaluate the model response 356 based on a prompt. In some implementations, at least one of the auxiliary ML models 358-1-358-N can be a vLLM.

The set of auxiliary ML models 358-1-358-N can include any number N of auxiliary ML models, where N is an integer greater than or equal to 1. In some examples, each auxiliary ML model corresponds to a respective one of the multiple modalities included in the training data 354. Each auxiliary ML model 358-1-358-N can have been trained on data of its corresponding modality. If N is greater than 1, each of auxiliary ML models 358-1-358-N can process the model-response 356 in parallel to at least one other of the multiple auxiliary ML models.

In some implementations, each of the auxiliary ML models 358-1-358-N can evaluate the model response 356 by comparing the model response 356 to corresponding ground truth data. Each auxiliary ML model 358-1-358-N can generate a respective output that characterizes the quality of the model response 356. For example, the respective output generated by an auxiliary ML model can include at least one of a quantitative score or qualitative feedback generated by the auxiliary ML model.

In some implementations, the quality of the model response 356 is represented using a composite reward score generated as a weighted combination of multiple individual reward components. For example, the outputs of the auxiliary ML models 358-1-358-N can be individual reward components of a composite reward score. The individual reward components can represent one or more of: factual correctness, reasoning depth, coherence, or alignment with task-specific objectives.

For example, a reward function 360 can receive as input the individual reward components generated by the LLM agents 358-1-358-N and generate as output a composite reward score that represents a combination of the individual reward components. For example, the combination can be a weighted combination of the individual reward components. The composite reward score generated by the reward function 360 can be used to fine-tune the primary machine-learning model 352. In this way, the primary machine-learning model 352 is fine-tuned in accordance with the quality of the model-response 356 as evaluated by at least one of the auxiliary machine-learning models 358-1-358-N. For example, the primary machine-learning model 352 can be fine-tuned in accordance with the quality of the model-response 356 based on a supervised fine-tuning (SFT) process.

As shown in FIG. 3B, agents specializing in different modalities collaborate to ensure outputs are reliable and contextually validated before reaching the user. By utilizing advanced mathematical techniques such as Persistent Homology (PH) and multimodal tensor decomposition, the technology described herein identifies deeper, geometry-free relational patterns that traditional vector embeddings can potentially miss. This enhances robustness against noisy or incomplete data.

In summary, beyond simply leveraging knowledge graphs by LLMs for enhanced reasoning, the technology described herein optimizes knowledge graphs and improves latent data representation during the training process itself. By introducing self-evolving structures, causal reasoning mechanisms, and robust multi-agent validation, the described framework enables real-time knowledge refinement, potentially realizing greater accuracy and adaptability in AI-driven applications. By embedding sophisticated causal and adaptive graph reasoning directly within the model layer, the ability of LLMs to understand structured data is enhanced and generalization across tasks is improved. The integration of dynamically evolving knowledge graphs, coupled with multi-agent validation and causal inference techniques, establishes a new paradigm for AI reasoning. This in turn can lead to significant gains in robustness, accuracy, and interpretability, making AI systems more reliable for high-stakes applications such as cybersecurity, scientific research, and multimodal knowledge integration.

Counterfactual Analysis in LLMs: Counterfactual analysis can enable LLMs to reason about hypothetical scenarios by simulating alternative prompts, parameter settings, or training data compositions. Giving counterfactual information⁴ can help identify causal relationships between input modifications and output variations, potentially revealing how different prompting strategies or context windows might have altered the model's responses. LLMs can perform self-evaluation through this lens by comparing actual outputs against idealized counterfactual outputs, providing feedback loops that refine performance and alignment over successive interactions. 4 Dehghanighobadi, Z., Fischer, A., & Zafar, M. B. (2025). Can LLMs explain themselves counterfactually?

The advanced LLM architectures leverage counterfactual reasoning to simulate “what if” scenarios or “let's double check my reasoning” during self-critique phases, evaluating alternate response paths before finalizing outputs. Alternative trajectory assessment allows LLMs to compare potential response strategies against each other, selecting those that optimize for accuracy, helpfulness, and harmlessness during information exploration. This capability enables more sophisticated error correction and continuous self-improvement when navigating complex informational environments, ultimately enhancing the model's utility as an exploration tool.

Graph Structure in LLM Knowledge Representation: The density of connections in LLM knowledge graphs reflects how extensively concepts are interlinked within the model's parametric memory, with higher densities indicating more comprehensive contextual understanding. This addresses the issues associated with very large models that data that may be disconnected or unable to access relevant information despite training on large amounts of data⁵. Clustering coefficients reveal how LLMs organize related information into conceptual neighborhoods, forming specialized knowledge domains that facilitate more coherent responses when queries target specific subject areas. The overall connectivity patterns demonstrate how effectively LLMs can traverse between seemingly disparate topics, supporting their ability to make creative connections and analogies during information exploration tasks. 5 Mahapatra, J., & Garain, U. (2024). Impact of model size on fine-tuned llm performance in data-to-text generation: A state-of-the-art investigation.

Relationship Strengths in LLM Associations: LLMs encode relationship strengths through semantic similarity calculations that quantify conceptual proximity between entities in their vector spaces, allowing for nuanced retrieval of associated information during inference. Information flow metrics within LLM attention mechanisms determine how activation patterns propagate through the network, influencing which conceptual relationships receive emphasis during response generation and how effectively the model can maintain coherence across long contextual windows when exploring complex informational landscapes.

Learning Dynamics in LLM Information Exploration: The exploration-exploitation ratio in LLMs governs how they balance generating novel, creative responses (exploration) versus leveraging well-established patterns (exploitation) during information search and synthesis. LLMs have been shown to be able to identify problems that need either exploitation or exploration⁶. Confidence calibration in LLM predictions determines when the model should hedge uncertain claims versus assertively present information, directly impacting how reliably it can guide users through unfamiliar knowledge domains. Modern LLMs dynamically adjust these parameters based on detected query ambiguity and domain familiarity to optimize information exploration efficiency. 6 Harris, K., & Slivkins, A. (2025). Should you use your large language model to explore or exploit?

Causal Graph Neural Networks with CounterFactual Regret Minimization (CFRM): The goal of using causal graphs is to confirm that CFRM significantly improves causal reasoning by correcting erroneous paths. The speed and accuracy of the proposed system, which identifies and corrects these through counterfactual simulation, can be measured and compared against a baseline system without CFRM. Counterfactual Regret Minimization (CFRM) is an optimization framework from game theory that dynamically adjusts decision-making based on past mistakes⁷. The techniques described herein can extend the standard Graph Neural Networks (GNNs) by integrating causal reasoning layers that simulate alternative realities forcing the model to predict counterfactual outcomes if certain relationships in the graph were changed. If CFRM is applied to minimize regret in decision making forcing the LLM to continuously adjust its reasoning by comparing different causal paths and avoiding past mistakes that led to hallucinations. Bayesian causal inference can be used to refine the graph's structure in real-time, continuously learning which relationships are to be prioritized. Combining causal graphs with CFRM transforms LLM reasoning into a self-improving decision-making framework, thereby increasing the likelihood that wrong inferences get systematically corrected over time. 7 Brown, N., & Sandholm, T. (2019). Solving imperfect-information games via discounted regret minimization

In some implementations, a hierarchical causal inference layer can be introduced on top of the multimodal graph representation. This would construct causal graphs instead of relational graphs, enabling the LLM to reason about cause-effect relationships between different modalities rather than just identifying associations. Causal perturbation testing can then be implemented, where the system actively modifies graph nodes and observes downstream effects, allowing it to distinguish correlation from causation. By using counterfactual simulation to reduce hallucinations, the LLM is effectively forced to predict what would happen if certain graph nodes were modified, ensuring its reasoning aligns with real-world causality. This can significantly improve performance as compared to LLMs that often fail to distinguish strong correlation from true causation, leading to hallucinations and flawed reasoning. By making causal structures explicit, the technology described herein can significantly improve fact-grounded responses.

AKS-based hierarchical causal graphs introduce structured reasoning layers that differentiate correlation from causation⁸. Counterfactual perturbation testing is integrated to refine inference quality, allowing the system to simulate potential modifications in the graph and observe the resulting effects. This enforces a causally consistent reasoning pathway, minimizing hallucinations and logical inconsistencies. Bayesian causal networks are incorporated to further refine real-time inference, ensuring a continuously improving logical structure: 8 Agrawal, M., Kayal, N., & Saxena, N. (2004). Primes is in p. Annals of mathematics, 781-793

$${R}_{causal} = SCD ( {𝒢}_{i} , {𝒢}^{*} ) = {\sum }_{( i , j ) ∈ ε} {\vert {h}_{i}^{( t )} - {h}_{j}^{( t )} \vert}^{2} - {\sum }_{( i , j ) ∈ {ε}^{*}} {\vert {h}_{i}^{*} - {h}_{j}^{*} \vert}^{2} \qquad ( 9 )$$

The structural causal distance (SCD) measures the difference in edge weights between the estimated causal structure εₜ and the ground truth ε*, as described in Eq. 9.

Causal Graph Neural Networks with Counterfactual Regret Minimization (CFRM): AKS-driven counterfactual regret minimization (CFRM) introduces a dynamic adjustment mechanism that refines LLM reasoning over time. By continuously simulating alternative causal pathways, the system identifies and corrects erroneous inferences, preventing the reinforcement of misleading correlations. Bayesian optimization is applied to dynamically restructure the knowledge graph in response to real-world data shifts, ensuring continuous learning and adaptive reasoning.

Standard Graph Neural Networks (GNNs) can be extended by integrating causal reasoning layers that simulate alternative realities, forcing the model to predict counterfactual outcomes when certain relationships in the graph are altered. To minimize regret in decision-making, CFRM continuously adjusts the LLM's reasoning by comparing different causal paths and avoiding past mistakes that led to hallucinations. This adjustment process follows a contextual regret minimization approach, as expressed in Eq. 10, where regret Rₜ(P) accumulates over time by comparing the quality of taken actions against the optimal value function:

$${R}_{t} ( 𝒫 ) = {\sum }_{t = 1}^{T} [ Q ( {s}_{t} , {a}_{t} ) - V ( {s}_{t} ) ] . \qquad ( 10 )$$

By using Bayesian causal inference, the framework refines the graph's structure in real-time, continuously learning which relationships are to be prioritized. The updated policy, given in Eq. 11, prioritizes low-regret paths by ensuring that future decisions are influenced more by actions with minimal regret:

$${π}_{t + 1} ( a \vert s , ξ ) = max ( {R}_{t} ( s , a ) , 0 ) / \sum max ( {R}_{i} ( s , a ) , 0 ) . \qquad ( 11 )$$

Integrating causal graphs with CFRM can transform LLM reasoning into a self-improving decision-making framework. This ensures that incorrect inferences are systematically corrected over time, preventing the reinforcement of misleading correlations and enhancing overall reasoning accuracy.

Graph-Based Topology Optimization using Persistent Homology: Persistent Homology (PH) is a topological data analysis (TDA) method that identifies robust structures in high dimensional data by analyzing the persistence of topological features (holes, loops, and voids) across multiple scales. Instead of treating the multimodal graph as a fixed structure, apply persistent homology to extract higher order relational structures within the data (loops and clusters that encode contextual dependencies). The use of Betti numbers (which count the number of connected components, loops and voids in a topological space) to identify stable patterns that persist across different scales of reasoning allows LLMs to prioritize the structurally significant information. This in turn can suppress hallucinations (which typically arise from weak or spurious relationships) while reinforcing strong causal structures. Some embeddings rely on Euclidean distances, but using topological features provides a geometry free, more robust representation of relationships, making the LLM's understanding more resilient to noise and missing data.

Superiority of AKS-based causal graph creation over some embeddings can be demonstrated, for example, by implementing a basic multimodal data representation scenario using a test bench, and constructing embeddings and AKS driven causal graphs from the same dataset. Evaluating initial accuracy in extracting relevant, verifiable connections shows that AKS mathematics enhances Persistent Homology (PH) by refining higher-order relationships in multimodal data. The use of Betti numbers can produce robust pattern extraction across different reasoning scales, filtering weak connections while reinforcing stable, causally relevant structures. Vector embeddings often rely on Euclidean distances, but AKS-based topological features allow geometry-free, robust pattern recognition, improving model resilience against noise and incomplete datasets.

Multimodal Tensor Decomposition for Relational Learning: Tensor decomposition methods (like CP decomposition and Tucker decomposition) allow high dimensional relational data to be factorized into low rank components, revealing hidden structures. This can include, for example, modeling the multimodal knowledge graph as a high-dimensional tensor where different modalities (text, images, timeseries) represent different axes, and using tensor factorization to uncover latent relationships that are not immediately visible in some graph structures. This also includes dynamically compressing and expanding tensor components based on contextual relevance, allowing LLMs to focus on informative multimodal signals. Embedding based methods treat relationships as static, but tensor decomposition allows for dynamic, adaptive relational modeling, automatically filtering out noise and irrelevant associations which is a huge advantage in reducing hallucinations.

Dynamically refining multimodal relationships with topological optimization (Persistent Homology) can improve causal reasoning and error correction using game-theoretic regret minimization (CFRM). Deeper patterns can thus be extracted from multimodal embeddings using tensor factorization.

Tensor decomposition, enhanced by AKS methodologies, enables dynamic adaptation of knowledge representations. High-dimensional multimodal data is efficiently factorized into meaningful low-rank components, allowing LLMs to focus on the relevant features while filtering out noise. This method ensures that LLMs adapt contextually without overfitting to irrelevant data, improving scalability and robustness.

By integrating AKS-based mathematical optimization, the system achieves: dynamically refined multimodal relationships through self-optimizing graph learning, causal reasoning and error correction using advanced counterfactual regret minimization (CFRM), and deeper pattern extraction via tensor decomposition, enhancing multimodal inference quality.

Graph structures used in multimodal data representation can be inherently static, limiting their adaptability to evolving information. To address this limitation, AKS-enhanced self-evolving graphs can be used, where nodes and edges dynamically reweigh themselves based on feedback from Large Language Models (LLMs). This method integrates reinforcement learning and contrastive techniques to refine graph connections over time, improving inference accuracy while mitigating hallucination risks. By allowing the graph topology to change based on past queries and LLM-generated insights, a self-learning knowledge network can be created that enhances multimodal understanding beyond static vector embeddings.

Instead of using a fixed graph structure for multimodal data representation, the approach herein employs a self-evolving graph where edges and nodes dynamically reweight based on LLM feedback. This provides the advantage of dynamic topology adaptation, where the graph structure evolves by integrating context-aware relationships derived from multimodal interactions. Reinforcement learning mechanisms ensure edge weights are updated using correctness feedback from past inferences, strengthening only verified relationships. Different embeddings, such as text and image nodes, interact dynamically, reshaping the structure based on contextual dependencies rather than predefined vector spaces. Contrastive learning further guides edge reweighting to reduce incorrect associations and enhance resilience to noise and hallucinations.

The dynamic graph adapts by modifying edge weights and updating intersections when new edges are added. This process is formalized in the following Algorithm 1:

Algorithm 1 Add Edge and Update Intersections

| | |
|---|---|
| 1: | procedure ADD_EDGE(self, node1, node2, weight) |
| 2: | self.graph.add_edge(node1, node2, weight) |
| 3: | self.update_intersections(node1, node2) |
| 4: | end procedure |
| 5: | procedure UPDATE_INTERSECTIONS(self, node1, node2) |
| 6: | neighbors1 ← set(self.graph.neighbors(node1)) |
| 7: | neighbors2 ← set(self.graph.neighbors(node2)) |
| 8: | intersection_nodes ← neighbors1 ∩ neighbors2 |
| 9: | end procedure |

Two graph structures are illustrated below: one with weighted edges and another representing text relationships:

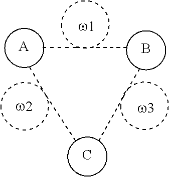

A textual modality representation is shown below:

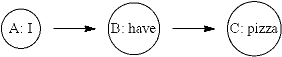

The effectiveness of the self-evolving graph is validated by incorporating it into an attention mechanism. The self-evolving graph contributes a structural prior, improving context retention during inference. The spectral adaptation function is defined in Equation 12:

$$S ( A , B , C ) = f ( {w}_{1} , {w}_{2} , {w}_{3} ) + {Δ}_{emb} ( C ) + {Δ}_{emb} ( B ) + {Δ}_{emb} ( A ) \qquad ( 12 )$$

In Equation 12 where f(w₁, w₂, w₃) represents the dynamic reweighting function and Δ_{emb}(X) denotes embedding adjustments from LLM feedback. The graph can be integrated into an attention-based model. Eq. 13 can define the attention mechanism, where S(A, B, C) influences the self-attention mechanism by modifying similarity scores dynamically.

$$Attention ( Q , K , V ) = softmax ( \frac{{QK}^{T}}{\sqrt{{d}_{k}}} + S ( A , B , C ) ) V \qquad ( 13 )$$

To validate the effectiveness of the proposed approach, multiple rounds of inference were conducted on a multimodal dataset, tracking improvements in accuracy and adaptability. Inference accuracy was compared using static graphs versus AKS-enhanced self-evolving graphs, to quantify how graph weights evolve over multiple iterations and measure reductions in false associations through reinforcement-driven edge updates. AKS-enhanced self-evolving graphs can be configured to dynamically refine knowledge representations based on LLM feedback. By integrating reinforcement learning and contrastive optimization, the proposed approach ensures greater adaptability and accuracy in multimodal inference tasks.

In some implementations, integrating a multi-agent system (MAS) within an AKS-optimized graph reasoning framework allows multiple autonomous verifiers to collaboratively refine and validate LLM outputs. Each agent specializes in distinct modalities, enabling robust cross-verification before finalizing a response. The evidence-weighting framework prioritizes verifiable, contextually relevant relationships, eliminating unreliable inferences. Thus, the proposed system shifts LLM reasoning from single-pass inference to a multi-agent validation loop, improving accuracy and reliability.

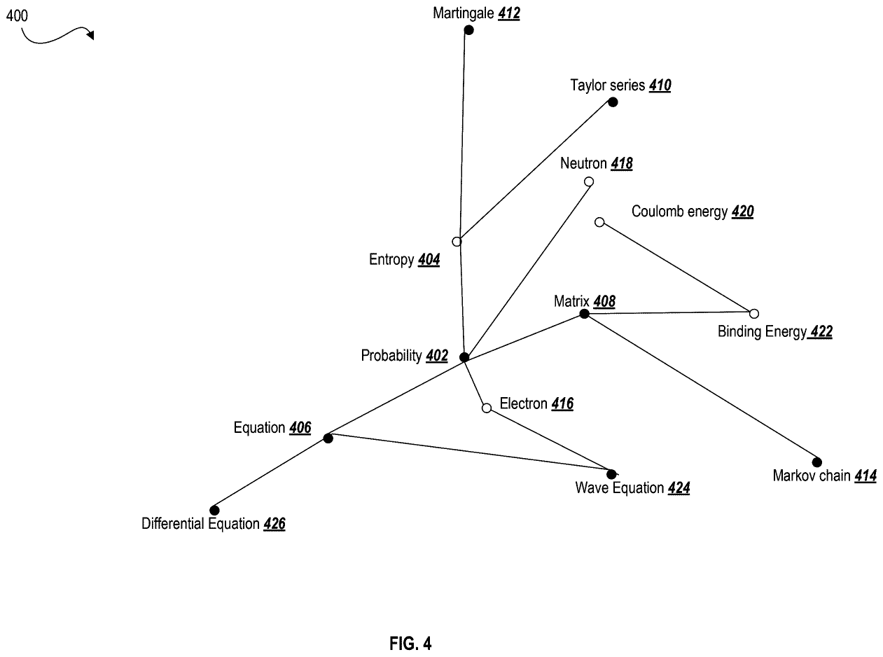

FIG. 4 is an example of a visual representation of a knowledge graph 400 that represents the relationships between mathematical and scientific concepts. For example, solid (black) nodes, such as the node 402, correspond to mathematical terms. Hollow (white) nodes, such as the node 404, denote scientific terms. The network structure reveals a dense central core comprising fundamental topics such as probability (node 402), equation (node 406), matrix (node 408), and entropy (node 404), which serve as intersections between the two domains. More specialized concepts branch outward from this core, forming distinct clusters. Mathematical terms, including Taylor series (node 410), Martingale (node 412), and Markov chain (node 414), predominantly occupy the upper-left and right portions of the graph, whereas science-related terms, such as electron (node 416), neutron (node 418), Coulomb energy (node 420), and binding energy (node 422), are more concentrated in the lower and right sections. Several bridging concepts, such as entropy (node 404), wave equation (node 424), and differential equation (node 426), highlight interdisciplinary connections between the two fields. The graph structure suggests a force-directed layout, where highly connected nodes cluster together, reinforcing their interdependence.

In various implementations, the disclosed technology can provide one or more of the following advantages.

Hallucination Reduction: The integration of hierarchical causal graphs, counterfactual regret minimization, and self-evolving graph structures directly addresses causes of hallucinations. Causal perturbation testing and counterfactual simulation force the LLM to differentiate correlation from causation, significantly reducing incorrect associations. MAS validation frameworks and evidence weighting allows for verifiable relationships to persist in the reasoning process. Graph-based topology optimization using Persistent Homology mathematically suppresses weak or spurious relationships.

Intelligence (Generalization and Adaptability): The self learning graph structure allows the model to dynamically adapt over time, making it more capable of handling unseen data. Tensor decomposition and graph based relational learning enhance the depth of pattern recognition. MAS consensus mechanisms introduce a form of collective intelligence, further improving decision making accuracy. Bayesian causal inference refines the system in real-time, ensuring intelligent adjustments to the knowledge representation.

Reasoning (Logical Consistency and Depth): The introduction of structured, explicit causal graphs ensures that reasoning is based on real-world cause-and-effect relationships rather than associative correlations. Counterfactual regret minimization continuously refines the model's decision pathways, enforcing a structured approach to inference. Dynamic multimodal tensor factorization enables the model to focus on relevant signals, preventing overfitting to irrelevant data. The shift from vector-based embeddings to relational graph structures rewires the reasoning process, improving logical consistency.

Low latency, High throughput training: In some implementations, the proposed approach can be implemented using a deep learning optimization library such as DeepSpeed provided by Microsoft AI. DeepSpeed is a software library for the efficient training and deployment of largescale models, particularly due to its advanced capability to optimize resource use through parallelization. As neural network architectures, especially transformer-based models, continue to grow dramatically in size, standard training methods quickly exceed the memory and computational limits of individual GPUs or even multiple GPU nodes. DeepSpeed addresses these challenges by providing techniques such as the Zero Redundancy Optimizer (ZeRO), pipeline parallelism, and tensor parallelism, which partition models and computation across multiple GPUs or distributed nodes. This partitioning significantly reduces the memory footprint, allowing models far larger than the available memory of any single GPU to be trained effectively. Additionally, deep learning optimization libraries such as DeepSpeed enhance training performance by minimizing redundancy in parameter storage, streamlining gradient computation, and efficiently orchestrating data transfers across hardware resources.

Supervised Fine-Tuning (SFT): SFT is the process of taking a pre-trained language model and further training it on carefully curated examples of desired behavior. The process begins with a foundation model that has already learned language patterns from a broad corpus of text data. The model is then trained using a specialized dataset containing examples of input prompts paired with ideal responses that demonstrate the specific behaviors for the model to learn. During training, the model is presented with these input prompts, generates its own responses, and then has its weights updated based on how closely its outputs match the ideal responses in the dataset. This is accomplished through a standard training loop where loss is calculated between generated and target outputs, and backpropagation adjusts the model weights to minimize this difference. SFT depends heavily on hyperparameters like the learning rate and batch size to avoid catastrophic forgetting of previously learned capabilities. This method involves continuous evaluation against validation sets throughout the training procedure to track progress and ensure the model is not overfitting.

Global Relative Policy Optimization (GRPO)⁹: GRPO is an extension of reinforcement learning approaches that addresses some limitations of popular methods like Proximal Policy Optimization¹⁰ and Trust Region Policy Optimization¹¹. GRPO focuses on optimizing policies relative to a global reference distribution rather than just comparing a new policy to the immediate previous policy. This approach provides several advantages. For example: 9 Shao, Z. Wang, P., Zhu, Q., Xu, R., Song, J., Bi, X., Zhang, H., Zhang, M., Y. K. Li, Y. W.,& Guo, D. (2024). Deepseekmath: Pushing the limits of mathematical reasoning in open language models. 10 Schulman, J., Wolski, F., Dhariwal, P., Radford, A., & Klimov, O. (2017). Proximal policy optimization algorithms 11 Schulman, J., Levine, S., Moritz, P., Jordan, M. I., & Abbeel, P. (2015). Trust region policy optimization
Better Stability: By maintaining a global reference distribution, GRPO can avoid the problem of policy drift that can occur in methods like PPO where small acceptable changes can compound over many updates.
Improved Sample Efficiency: GRPO can better utilize historical data by relating current policy updates to a more stable reference point.
Consistent Optimization Objective: Rather than having a moving optimization target that changes with every policy update, GRPO maintains a more consistent objective.

Although GRPO has demonstrated exceptional efficacy in training Large Language Models, it also uses a significantly higher amount of memory at the fine tuning stage. Unlike simpler reinforcement learning approaches, GRPO involves maintaining multiple copies of the model simultaneously—the policy model being optimized, a reference model to prevent excessive deviation, and often a reward model to evaluate outputs. The process can include computing pairwise comparisons between different policy outputs across a large batch of prompts. This can create a quadratic relationship between batch size and computational requirements, as each sample can be compared against many others to establish global preference rankings. Additionally, GRPO's training dynamics can involve calculating complex gradients through multiple inference passes. For each training step, the model can be configured to generate multiple completions per prompt, compute rewards, establish relative preferences, and then backpropagate through this entire process. The global nature of the preference optimization means that the work cannot be partitioned across multiple smaller GPUs without significant communication overhead. The process can therefore be configured to access global information about all samples in a batch to properly establish relative preferences. Finally, the high-dimensional optimization landscape of GRPO often implicate using larger batch sizes to achieve stable training, further increasing memory demands. These factors can combine to make GRPO exceptionally GPU-intensive compared to other fine-tuning approaches.

### Agent for Supervised Finetuning Enhancement Through Data Enhancement

Integration of an additional agent at two different stages of training was evaluated. The first method involved incorporating an auxiliary agent during supervised fine-tuning (SFT). This additional agent plays a role in evaluating the primary agent's responses and injecting information to improve the training signal. Specifically, the smaller model (i.e., the model trained to execute the functions of the additional agent) acts as a data quality enhancer during the supervised fine-tuning phase, enhancing the dataset used for training.

The second problem is that of the effect of latency during the training process and how multiple agents can be used during the training process in the first place. The additional agent described herein enhanced SFT approach builds upon recent developments in data curation strategies, allowing the technology to extend beyond filtering mechanisms to implement an active, agent-based data enhancement paradigm. The smaller model served as a “critic” that evaluates responses along multiple dimensions: factual accuracy, logical coherence, and alignment with intended training objectives. This multi-dimensional evaluation allows for more nuanced data quality assessment compared to simpler heuristic approaches. The agent can be configured to operate, for example, by analyzing each training example in a streaming fashion, producing both a quantitative score and qualitative feedback. This feedback can be incorporated into the training process in a way in which the original training signal is preserved but is enhanced with the agent's evaluation. In some implementations, an agent reward function can be used during the training process to indirectly steer the model to interpret the data itself without relying on the agent during inference time.

### Agentic Reward Function Enhancement for Reinforcement Learning:

The second integration point was the introduction of an additional reward function into the training process. This can involve, for example, passing a secondary reward model to refine the reward signals used in training. Rather than directly modifying the data, which could lead to issues during training, reinforcement learning allows for the model to learn improved data representations on its own. So rather than using supervised fine-tuning to enhance data, this method instead uses simple rewards ranging from 0-1 to modify the model parameters in order to generate higher-quality outputs using a reward function. The auxiliary agent, in this case, was designed to generate a more intelligent reward signal compared to some existing methods, effectively improving the reinforcement learning signal for fine-tuning.

Building on the foundation of recent advances in reinforcement learning from human feedback (RLHF), the agent reward function disclosed herein introduces several innovations. Unlike reward models that provide scalar values based on pre-defined criteria, the agent-based approach described herein implements a dynamic reward modeling system that adapts to different contexts and reasoning patterns. The auxiliary model can be configured to analyze responses across multiple dimensions, including problem-solving approach, step-by-step reasoning quality, and solution validity. This multi-dimensional reward framework can be represented using the compositional function:

$$R ( x ) = {\sum }_{i = 1}^{n} {w}_{i} \cdot {r}_{i} ( x ) ,$$

where each rᵢ represents a specific reward component, and wᵢ represents its corresponding weight. These components include evaluations of factual correctness, reasoning depth, coherence, and alignment with task-specific objectives. The weights wᵢ are initially set based on task parameters but can be dynamically adjusted during training based on validation performance.

An example of the specific prompt to the agent can be as follows:
“You are an expert evaluator of language model outputs. Your task is to analyze the given text and provide a single quality score.
Analyze the text based on:
   Factual consistency
   Absence of hallucinations
   Completeness
   Lack of redundancy
   Coherence and logical flow
After analysis, output ONLY a single integer between 1 and 100 representing the overall quality. 1=extremely poor quality, 100=exceptional quality. DO NOT include any explanation, analysis, or additional text in your response.
Your entire response must be just a single integer from 1-100.”

A significant advantage of the proposed approach is the ability to provide non-Markovian rewards that consider the entire sequence of reasoning steps rather than just the final output. This encourages the model to develop robust problem-solving strategies instead of simply optimizing for the end result. For complex reasoning tasks in particular, the agent evaluates the validity of each intermediate step, rewarding proper application of mathematical principles even when the final answer may be incorrect due to calculation errors. A comparative ranking mechanism can also be used, where the agent evaluates multiple candidate responses from the primary model, creating a preference ranking that is used to refine the policy gradient updates. This relative preference modeling proved more stable than absolute reward scoring, particularly for complex reasoning tasks.

Different models can be used as the primary model and for implementing the additional agents described herein. In some implementations, a full-scale Qwen-32B model—trained using reinforcement learning fine tuning techniques described herein—can be used as the primary model, and the Qwen-0.5B model provided by Hugging Face can be used as the smaller model. In some implementations an optimized inference framework designed for large-scale language model—e.g., Ollama—can be used for the additional agents. Using Ollama can provide for efficient memory management and high-performance batching, making it suitable for frequent, parallel access to a smaller assistant model. In some implementations, an Ollama-based smaller model provided real-time feedback to the Qwen-32B primary model without introducing prohibitive inference costs. This enhancement can allow for maintaining high training efficiency while incorporating an auxiliary agent to refine rewards and prompt improvement mechanisms. In some implementations, Ollama can be deployed via Helm, thus allowing Ollama to run seamlessly within a Kubernetes environment. This in turn can support efficient deployment and scalability of models across the cluster.

In some implementations, virtual Large Language Models (vLLMs) can be leveraged to significantly enhance the proposed system's performance and scalability. For example, using vLLMs can reduce training latency per step of the original Qwen-32B with the additional agent by a factor of 2 or more as compared to non-vLLM systems. vLLMs achieve the reduced latency, for example, through optimized GPU utilization, efficient memory management, and/or advanced batching capabilities, enabling rapid parallel processing of requests. These capabilities make vLLM highly suitable for assistant-agent architecture described herein, facilitating more frequent and parallel interactions with a smaller assistant model. This in turn can allow the smaller model to efficiently handle multiple simultaneous requests, thereby improving overall responsiveness and user experience.

### Experimental Results

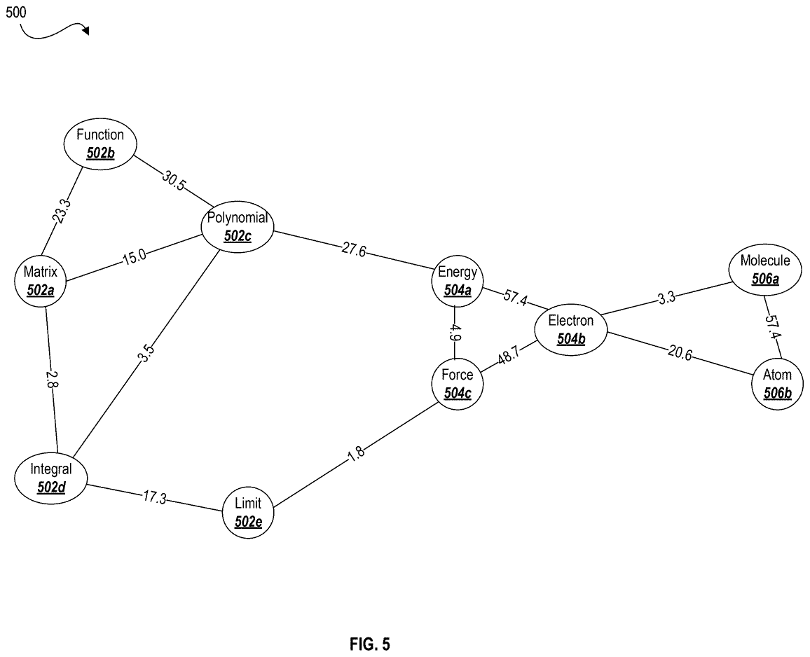

FIG. 5 is another example visualization of a knowledge graph 500 grouped by problem category, where the set of nodes 502a-e represent mathematical concepts, the set of nodes 504a-c correspond to physics concepts, and the set of nodes 506a-b denote chemistry-related topics. The structure of the graph 500 reveals distinct clustering of knowledge areas, with mathematics forming the foundation at the bottom, physics occupying the middle, and chemistry concepts positioned at the top. The connections between nodes indicate conceptual relationships, with edges labeled by weights that likely represent the strength or frequency of these connections. The dense interconnections among math and physics suggest a strong dependency between these fields, whereas chemistry maintains distinct yet linked connections to both. The overall structure of the graph implies a knowledge dependency where fundamental mathematical principles, e.g., as represented by the set of nodes 502a-e, support the formulation and understanding of physical and chemical phenomena, e.g., as represented by the sets of nodes 504a-c and 506a-b. The grouped layout emphasizes this structured hierarchy, making it clear how foundational knowledge in mathematics contributes to advancements in physics and chemistry.

To enhance the knowledge graph 500 of FIG. 5, the connections between different problem types can be strengthened by identifying and incorporating similar reasoning as edge relationships. The table below provides a structured categorization of reasoning expressions used in mathematical problem-solving, which can be leveraged to add possible edge connections between problem nodes in the knowledge graph. Each entry in the table represents a different reasoning approach, transition, or mathematical domain, offering a framework for linking concepts based on how they are analyzed or formulated.
The “Analysis Approaches” category introduces expressions related to case analysis, verification, error detection, and concrete examples, which can define edges between problem nodes based on methodological similarities.
The “Reasoning Transitions” section highlights inference-based links, alternative problem-solving strategies, and mathematical formulations, suggesting natural connections between nodes where multiple approaches can be applied to solve related problems.
The “Mathematical Domains” section provides additional structure for forming edges between problems belonging to the same branch of mathematics, such as number theory, probability, algebra, and calculus.
The “Logical Methods” category outlines deduction, induction, abduction, and abstraction, which can further define relationships between nodes based on logical dependencies.

By incorporating these categories, the table enables a systematic way of adding edges between problem nodes, ensuring that the graph not only captures direct concept dependencies but also reflects the variety of reasoning strategies that link different mathematical and scientific topics.

| | |
|---|---|
| Category | Expression |

Analysis Approaches with CFRM

| | |
|---|---|
| <case_analysis> | Let me analyze this by considering different |
| | cases and their likely outcomes. |
| <verification> | I should verify this result by checking our |
| | work and comparing against alternative |
| | solutions. |
| <error_detection> | I notice an error in our previous reasoning. |
| | Let me recalibrate our approach. |
| <example> | Let's consider a concrete example to |
| | illustrate and test different strategies. |

Reasoning Transitions

| | |
|---|---|
| <inference> | From this, I can infer that |
| <alternative_approach> | Let me try an alternative approach to minimize |
| | potential regret from suboptimal strategies. |
| <formulation> | I'll formulate this problem mathematically, |
| | considering multiple representations. |

Mathematical Domains

| | |
|---|---|
| <number_theory> | Using principles from number theory, |
| <probability> | Applying probability concepts, |
| <algebra> | Through algebraic manipulation, |
| <calculus> | Using calculus techniques, |
| <geometry> | From a geometric perspective, |

Logical Methods with CFRM

| | |
|---|---|
| <deduction> | I can deduce from known facts that |
| <induction> | Using mathematical induction, |
| | I'll show that |
| <abduction> | Our hypothesis to explain this observation is |
| <abstraction> | Let me abstract this into a more general |
| | framework to evaluate solution paths. |
| <general_reasoning> | Using logical reasoning, |

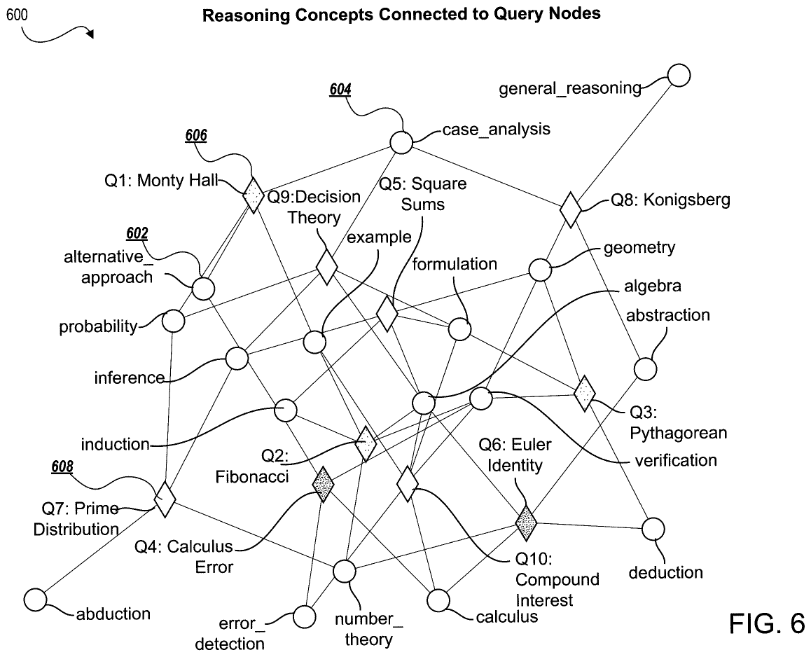

FIG. 6 is another example visualization of a knowledge graph 600. The graph 600 is an enhanced knowledge graph with reasoning tags, which presents a graphical representation of reasoning concepts connected to query nodes, illustrating the dynamic relationships formed through interactions. The reasoning concepts are represented by circular nodes in FIG. 6, such as the node 602 and the node 604. The query nodes are represented by diamond-shaped nodes in FIG. 6, such as the node 606 and the node 608.

The connections between problem categories and associated tags underscore the contextual dependencies that emerge through iterative inference processes, reinforcing the role of dynamic graph adaptation in enhancing multimodal knowledge extraction.

The training data for each experiment consisted of 1000 math-based thinking trajectories with the goal of improving overall reasoning leveraging the knowledge graph technique. Preliminary results showed that implementing the knowledge graph categorical tag methodology (table below) during the fine-tuning phase led to a 3.3% improvement on the base Qwen2.5-32B-Instruct model for the AIME24 evaluation task. Further improvements to the graph tags through the use of natural language expressions led to a 6.3% improvement on the Qwen2.5-32B-Instruct (table below) with this same task. Each experiment was run on 64 H200 Nvidia GPUs with a total training time of about 2 hours.

| Model | AIME 24 |
|---|---|
| Qwen2.5-32B-Instruct | 20.0 |
| Qwen2.6-32B-Instruct w/Knowledge | 23.3 |
| Graph Tags | |
| Qwen2.6-32B-Instruct w/Natural | 26.3 |
| Language Knowledge Graph Tags | |

The technology described herein introduces a fundamentally different way for LLMs to process and understand multimodal data, making them more reliable, accurate, and context-aware than RAG. The end result is a new mathematical framework that enhances the ability of LLMs to process multimodal and multi-source data by integrating reinforcement learning-based knowledge graph learning. This enables structured, dynamic knowledge representation that surpasses some existing prompt engineering and RAG-based methods. The integration of reinforcement learning with knowledge graph based reasoning allows LLMs to dynamically adapt and self-optimize. This results in structured knowledge graphs that evolve with LLM outputs, improving long-term accuracy.

Some existing implementations of AI incorporate Graph Neural Networks (GNNs) for relational understanding. However, reinforcement learning-driven graph transformations offer a superior alternative by reinforcing causal structures while suppressing weak correlations. This enables context-aware data preprocessing, reducing the need for extensive prompt engineering. Unlike RAG, which retrieves pre-embedded semantic similarities, the technology described herein natively incorporates structured reasoning, enhancing the LLM's ability to handle complex multimodal relationships. This approach significantly reduces hallucinations by ensuring that only verified, causally relevant connections persist in knowledge representations. A calculation that models the multi model data or any multi-source/vector data in a graph and allows the LLM to find the relationship in the graph. This would be a way of pre-processing mechanism for data instead of prompt engineering or RAG. Modeling multimodal or multi-source/vector data in a graph can allow an LLM to find relationships within the graph.

Some existing AI systems use graph neural networks (GNNs) to process structured relationships between entities. Knowledge graphs (KGs) and multimodal fusion techniques are used in retrieval-augmented generation (RAG) and other LLM applications. LLMs show proficiency in embedding-based similarity analysis, and as such, they can be configured to process a graph's node and edge representations to derive new relationships. This can also be enhanced by using attention-based transformers trained on structured graph embedding. A graph-based preprocessing mechanism could work similarly to vector databases but would encode relational rather than semantic similarities. This could streamline how LLMs handle structured data, improving accuracy while reducing reliance on engineered prompts. RAG relies on embedding retrieval from a vector store, but the method described herein would integrate graph-structured data natively, making it a more context-aware approach. This could significantly reduce hallucination issues via appropriate constraints with a graph-based reasoning layer. In some implementations, the technology can include an adaptive mechanism where the graph structure evolves based on LLM outputs, thereby improving future predictions.

In some implementations, the Counterfactual Regret Minimization can be configured to enhance causal reasoning in LLMs by dynamically adjusting decision-making based on simulated alternative scenarios. In some implementations, this game theory-inspired approach can help LLMs avoid repeating past mistakes that led to hallucinations, for example. In some implementations, sophisticated feedback mechanisms can be incorporated into the reasoning graphs and training process, thereby facilitating more efficient training in runtime and reasoning. The framework can be expanded, for example, through multi-modal integration capabilities and cross-domain generalization as well. In some implementations, knowledge graphs can be actively optimized during the training process through self-evolving structures, causal reasoning mechanisms, and/or multi-agent validation.

In some implementations, the supervised fine-tuning (SFT) phase can be configured to leverage an auxiliary agent to enhance data quality actively. For example, a smaller Qwen-0.5B model can be configured to act as a data quality evaluator during the supervised fine-tuning phase. This can include, for example, an additional agent serving as a data critic, assessing the primary model's responses along multiple dimensions, including factual accuracy, logical coherence, and alignment with training objectives. This multiagent setup introduces nuanced quality assessment and iterative refinement of training samples. In some implementations, the auxiliary agent can be configured to assign a quality score to each response, augmenting the dataset by enhancing the data points rated highly for training. The smaller agent—Qwen-0.5B in one example—provides granular feedback, effectively increasing the quality and relevance of training data through selective enhancement or filtering based on the quality scores.

During the reinforcement learning phase, a sophisticated agentic reward function can be integrated into the process. Instead of directly modifying training data, which may disrupt model stability, this reward function can be configured to indirectly steer the model's learning through dynamic, context-sensitive feedback. Formulated around an evaluation prompt, the reward function can be configured to assess responses for overall quality, problem-solving capability, and logical coherence, assigning scalar rewards based on these evaluations. The process can enable the primary model to autonomously learn improved data representations by internalizing nuanced feedback, thereby enhancing robustness and adaptability across diverse inference scenarios.

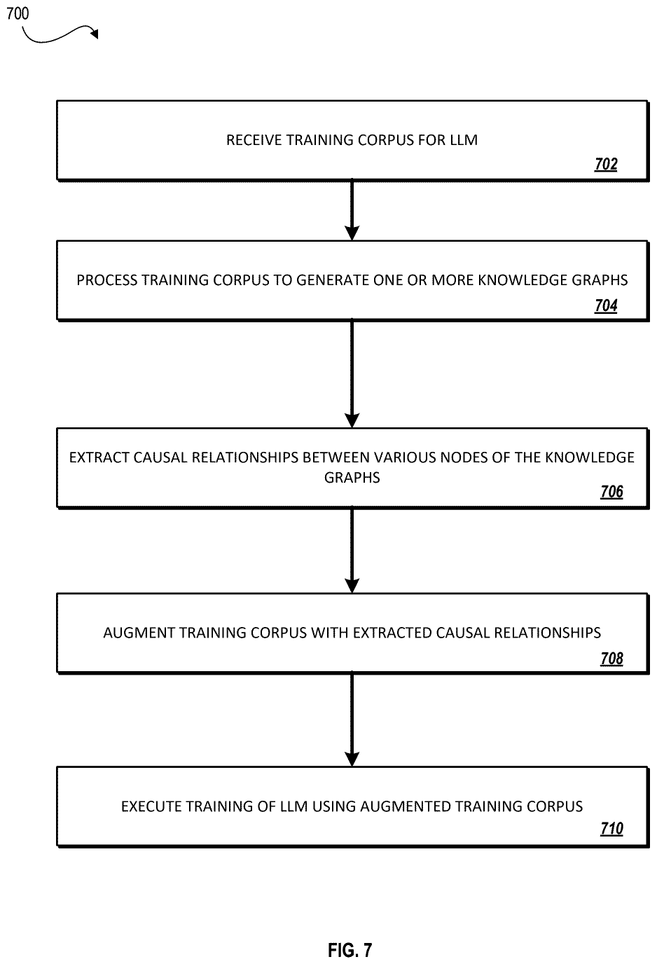

FIG. 7 is a flow diagram of an example process 700 for training a large language model (LLM). For convenience, the process 700 will be described as being performed by a system of one or more computers located in one or more locations.

The system receives a training corpus for the LLM (702). The training corpus can include multi-modal data.

The system processes the training corpus to generate one or more knowledge graphs (704). Each of the one or more knowledge graphs can include a plurality of nodes connected by a plurality of edges, such as the knowledge graph 100 of FIG. 1.

In some implementations, the one or more knowledge graphs comprise causal graphs indicative of cause-effect relationships among different modalities of the multi-modal data. The one or more knowledge graphs representing the multi-modal data can include multi-dimensional tensors where different modalities of the multi-modal data are represented as different axes.

The system extracts, from the one or more knowledge graphs, causal relationships between various nodes of the one or more knowledge graphs (706).

The system augments the training corpus with the causal relationships extracted from the one or more knowledge graphs (708).

The system executes a training of the LLM using the augmented training corpus (710). The system can train the LLM using the augmented training corpus by first processing data from the augmented corpus by the LLM to generate a model-response. The system can then process the model-response using at least one auxiliary machine-learning model to evaluate a quality of the model response. The system can update the training of the LLM in accordance with the quality of the model response. In some implementations, the at least one auxiliary machine-learning model is a generative artificial intelligence model configured to evaluate the model-output based on a prompt.

The system can execute the training of the LLM by updating weights of a self-attention mechanism associated with the LLM based on the causal relationships extracted from the one or more knowledge graphs. Similarity measures associated with the self-attention mechanism can be dynamically modified as a function of the updated weights.

In some implementations, the system dynamically updates the one or more knowledge graphs during the training of the LLM. For example, the system can dynamically update the one or more knowledge graphs using a counterfactual regret minimization (CFRM) process configured to simulate multiple alternative scenarios to predict corresponding outcomes. For example, the system can dynamically update the one or more knowledge graphs by preserving topological features that appear in multiple of the various alternative scenarios. The topological features can be identified using persistent homology (PH) analysis. At least one of the updated knowledge graphs represents a structural prior used during executing an inference process using the trained LLM.

While this specification contains many specific implementation details, these should not be construed as limitations on the scope of what is being claimed, which is defined by the claims themselves, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this by itself should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method of training a large language model (LLM), the method comprising:
receiving a training corpus for the LLM;
processing the training corpus to generate one or more knowledge graphs;
extracting, from the one or more knowledge graphs, causal relationships between various nodes of the one or more knowledge graphs;
augmenting the training corpus with the causal relationships extracted from the one or more knowledge graphs; and
executing a training of the LLM using the augmented training corpus.

2. The method of claim 1, wherein the training corpus comprises multi-modal data.

3. The method of claim 2, wherein the one or more knowledge graphs comprise causal graphs indicative of cause-effect relationships among different modalities of the multi-modal data.

4. The method of claim 1, further comprising dynamically updating the one or more knowledge graphs during the training of the LLM.

5. The method of claim 4, wherein the one or more knowledge graphs are dynamically updated using a counterfactual regret minimization (CFRM) process configured to simulate multiple alternative scenarios to predict corresponding outcomes.

6. The method of claim 5, wherein the one or more knowledge graphs are dynamically updated by preserving topological features that appear in multiple of the various alternative scenarios.

7. The method of claim 6, wherein the topological features are identified using persistent homology (PH) analysis.

8. The method of claim 4, wherein at least one of the updated knowledge graphs represents a structural prior used during executing an inference process using the trained LLM.

9. The method of claim 2, wherein the one or more knowledge graphs representing the multi-modal data comprises multi-dimensional tensors where different modalities of the multi-modal data are represented as different axes.

10. The method of claim 1, wherein training of the LLM using the augmented corpus comprises:
processing data from the augmented corpus by the LLM to generate a model-response;
processing the model-response by at least one auxiliary machine-learning model to evaluate a quality of the model response; and
updating training of the LLM in accordance with the quality of the model response.

11. The method of claim 10, wherein the at least one auxiliary machine-learning model is a generative artificial intelligence model configured to evaluate the model-output based on a prompt.

12. The method of claim 1, wherein executing the training of the LLM comprises updating weights of a self-attention mechanism associated with the LLM based on the causal relationships extracted from the one or more knowledge graphs.

13. The method of claim 12, wherein similarity measures associated with the self-attention mechanism are dynamically modified as a function of the updated weights.

14. A system of multi-agent reinforcement learning, the system comprising:
a primary machine-learning model configured to process training data to generate a model-response; and
at least one auxiliary machine-learning model configured to process the model response to evaluate a quality of the model response,
wherein the primary machine-learning model is fine-tuned in accordance with the quality of the model-response as evaluated by the at least one auxiliary machine-learning model.

15. The system of claim 14, wherein the primary machine-learning model is trained on multi-modal data comprising data of multiple modalities.

16. The system of claim 15, wherein each of the at least one auxiliary machine-learning model is trained on data of a corresponding one of the multiple modalities.

17. The system of claim 14, wherein evaluating the quality of the model response comprises comparing the model response to corresponding ground truth data.

18. The system of claim 14, wherein the primary machine-learning model is fine-tuned in accordance with the quality of the model-response based on a supervised fine-tuning (SFT) process.

19. The system of claim 14, wherein the quality of the model-response is represented by at least one of a quantitative score or qualitative feedback generated by the at least one auxiliary machine-learning model.

20. One or more non-transitory computer storage media encoded with computer program instructions that when executed by one or more computers cause the one or more computers to perform operations for training a large language model (LLM), the operations comprising:
receiving a training corpus for the LLM;
processing the training corpus to generate one or more knowledge graphs;
extracting, from the one or more knowledge graphs, causal relationships between various nodes of the one or more knowledge graphs;
augmenting the training corpus with the causal relationships extracted from the one or more knowledge graphs; and
executing a training of the LLM using the augmented training corpus.
